(19) United States
(12) Patent Application Publication
(10) Pub. No.: US 2013/0169552 A1
(43) Pub. Date: Jul. 4, 2013

(54) ELECTRONIC DEVICE AND METHOD FOR CONTROLLING ROTATION OR ZOOMING OPERATIONS ON TOUCH SCREEN

(71) Applicant: HSING-CHUN HSIEH, Shindian (TW)

(72) Inventor: HSING-CHUN HSIEH, Shindian (TW)

(73) Assignee: FIH (Hong Kong) Limited, Kowloon (HK)

(21) Appl. No.: 13/563,851

(22) Filed: Aug. 1, 2012

(30) Foreign Application Priority Data
Dec. 30, 2011 (TW) 100150014

(51) Int. Cl. G06F 3/041

(52) U.S. Cl. 345/173

(57) ABSTRACT

An electronic device sets a condition for triggering zooming operations or rotation operations of a file displayed on the touch screen. When the condition has been met, the device determines an equation of a movement route of an object on the touch screen according to data in relation to contacts from the object, determines a distance difference and a tangential angle difference between a present contact and a next contact, and determines whether the file needs to be rotated or zoomed based on an absolute value of the angle difference. When the file needs to be rotated, the device determines a rotation angle based on the angle difference, and controls a rotation operation of the file accordingly. When the file needs to be zoomed, the device determines a zoom ratio based on the distance difference, and controlling a zooming operation of the file accordingly.

### BACKGROUND

1. Technical Field

The embodiments of the present disclosure relate to touch screen control technology, and particularly to an electronic device and a method for controlling rotation or zooming operations on a touch screen.

2. Description of Related Art

In the touch screen field, single touch technology refers to recognizing a single contact point on a touch screen and control operations of objects (such as images, e-maps) displayed on a touch screen via operating function buttons, such as zoom in/zoom out buttons and rotation buttons. However, the operations realized by single touch technology are linear, which means a user can only zoom in/zoom out an object by a predefined proportion (such as 50%, 75%, 100%, 200%) or rotate the object by a predefine angle (often 90 degrees) at one time. Multi-touch technology refers to recognizing two or more contact points on a touch screen at the same time and can realize non-linear operations. However, multi-touch technology is expensive.

### BRIEF DESCRIPTION OF THE DRAWINGS

FIG. 1 is a block diagram of one embodiment of function modules of an electronic device including a control unit.

FIG. 2A and FIG. 2B are flowcharts of one embodiment of a method for controlling rotation or zooming operations on a touch screen of the electronic device in FIG. 1.

FIG. 3A, FIG. 3B and FIG. 3C illustrates a center of the touch screen, and contact points on the touch screen.

FIG. 4 illustrates a curve in relation to a movement route of an object.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

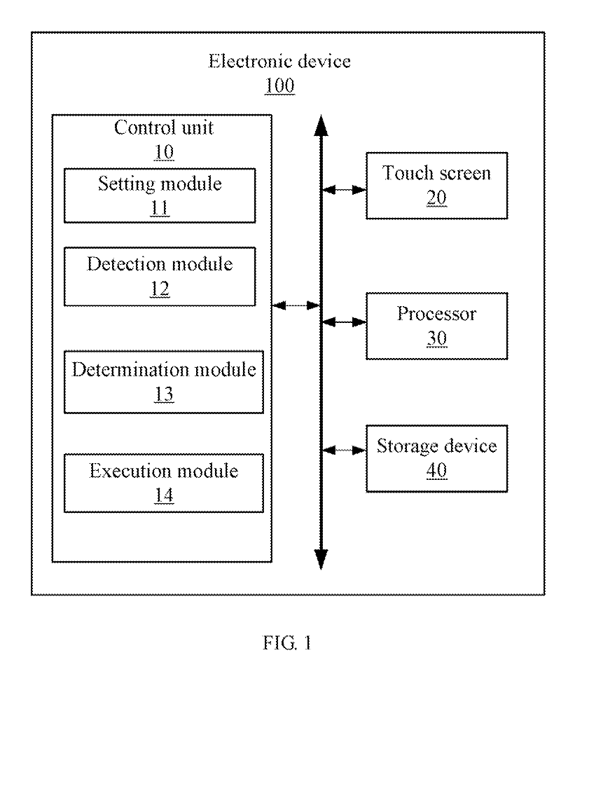

FIG. 1 is a block diagram of one embodiment of function modules of an electronic device 100. In one embodiment, the electronic device 100 includes a control unit 10, a touch screen 20, a processor 30, and a storage device 40. The touch screen 20 includes a touch panel and a display screen. The components 10-40 communicate with each other via a bus. One skilled in the art would recognize that the electronic device 100 would be configured in a number of other ways and may include other or different components. Depending on the embodiment, the electronic device 100 may be a mobile phone, a digital personal assistant, a personal computer, or any other suitable data processing device. The storage device 40 is a dedicated memory, such as an EPROM, a hard disk driver (HDD), or flash memory.

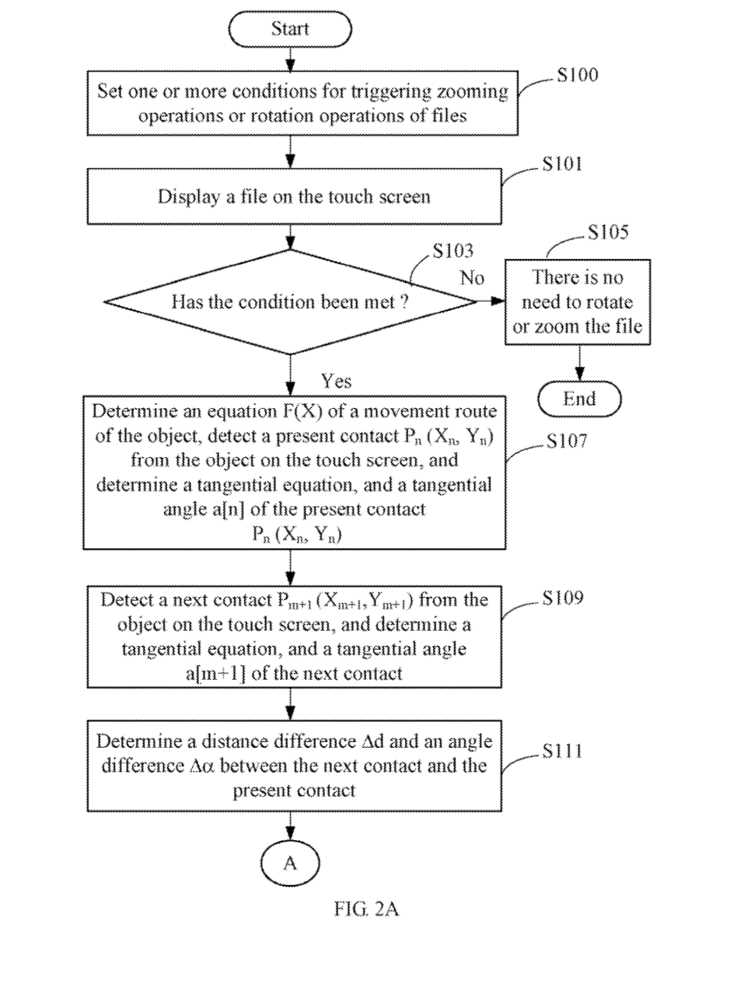

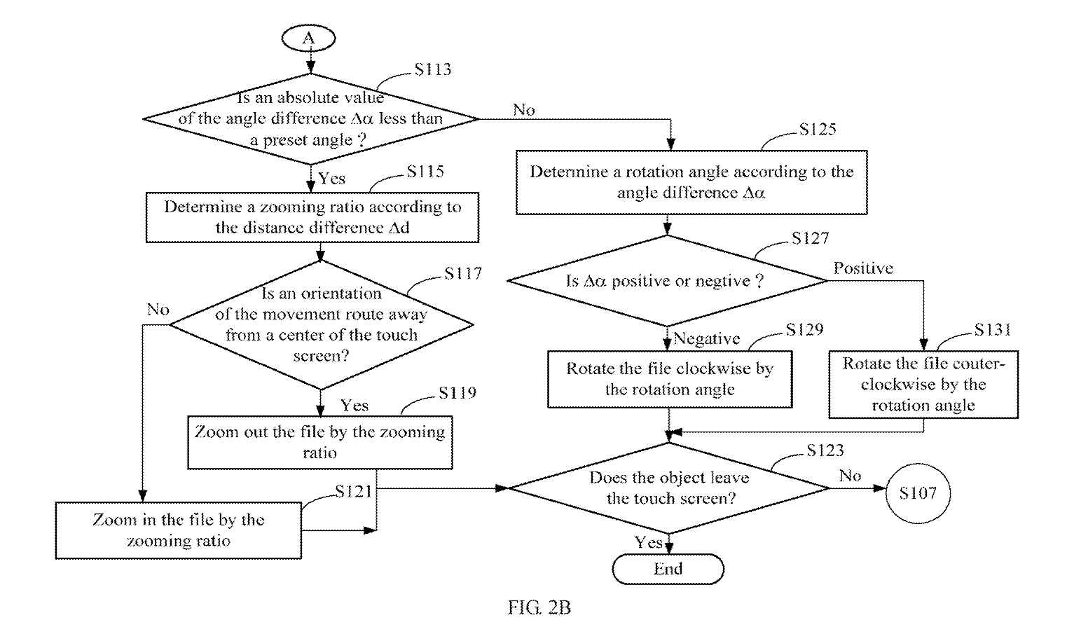

As shown in FIG. 1, the control unit 10 includes a setting module 11, a detection module 12, a determination module 13, and an execution module 14. The modules 11-14 may include computerized code in the form of one or more programs that are stored in the storage device 40. The processor 30 executes the computerized code to control rotation and zooming operations of files on the touch screen 20. A detailed description of functions of the modules 11-14 is given below in the descriptions regarding FIG. 2A and FIG. 2B.

FIG. 2A and FIG. 2B are flowcharts of one embodiment of a method for controlling rotation or zooming operations of files on the touch screen 20. Depending on the embodiment, additional steps may be added, others removed, and the ordering of the steps may be changed.

In step S100, the setting module 11 receives a condition for triggering zooming operations or rotation operations of files displayed on the touch screen 20. The condition is set by a user. In one embodiment, the user may be a designer of the control unit 10 or a common user (such as an owner) of the electronic device 100. In this embodiment, the condition may be two contacts are detected within a preset region of the touch screen 20 within a preset time period (such as 0.5 seconds), or a preset button of a keyboard (not shown) of the electronic device or a preset icon displayed on the touch screen 20 is pressed by the user. The setting module 11 stores the condition into the storage device 40.

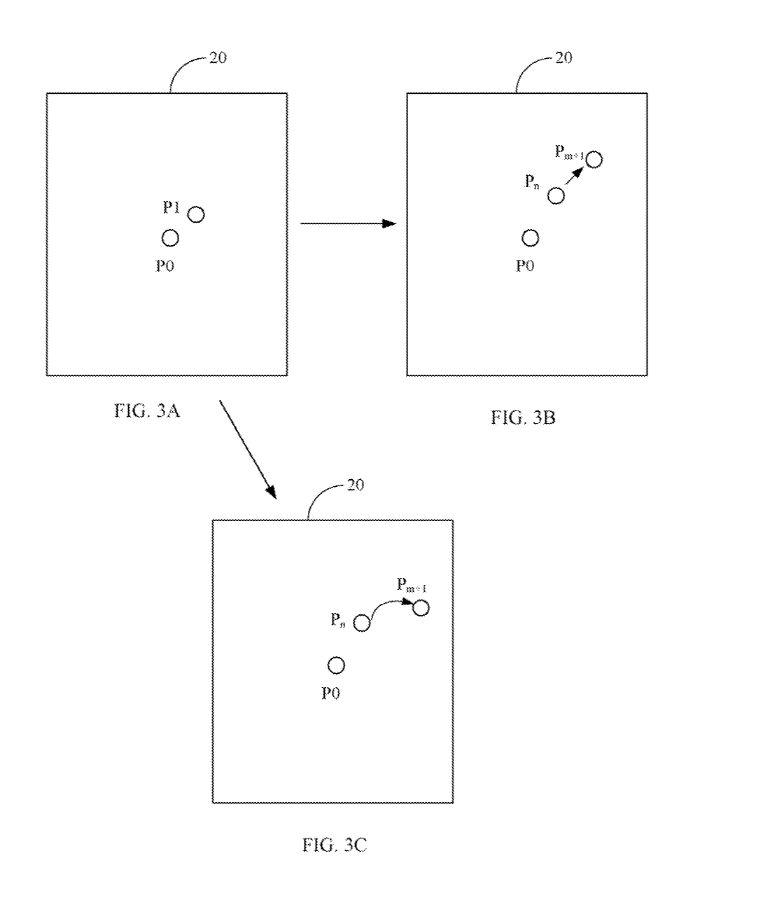

In step S101, a file is displayed on the touch screen, the file may be an image or a Web page, for example. The detection module 12 detects whether the condition for triggering zooming operations or rotation operations of the file has been met. Step S105 is implemented if the condition has not been met, or step S107 is implemented if the condition has been met. For example, if a first contact P1 having the coordinates (X1, Y1) (as shown in FIG. 3A) is detected from an object on the touch screen 20, the detection module 12 detects whether a second contact P2(X2, Y2) from the object has been detected within the preset region of the touch screen 20 within the preset time period (such as 0.5 seconds). For example, the preset region may be a circle by taking the first contact P1(X1, Y1) as a center and the preset value (such as 0.8 mm) as a radius of the circle. For another example, the preset region may be a square by taking the first contact P1(X1, Y1) as a center and based on the preset value, such as regarding the preset value as a side length or a half of the side length.

In step S105, the determination module 13 determines that there is no need to rotate or zoom in/zoom out the file, and the procedure ends.

In step S107, the detection module 12 detects coordinates (Xₙ, Yₙ) of a present contact Pₙ (as shown in FIG. 3B) from the object on the touch screen 20. The determination module 13 determines an equation F(X) of a movement route of the object on the touch screen 20 according to data in relation to three contacts from the object on the touch screen, and determines a tangential equation, and a tangential angle a[n] of the present contact Pₙ according to the equation F(X) of the movement route and the coordinates (Xₙ, Yₙ) of the present contact Pₙ.

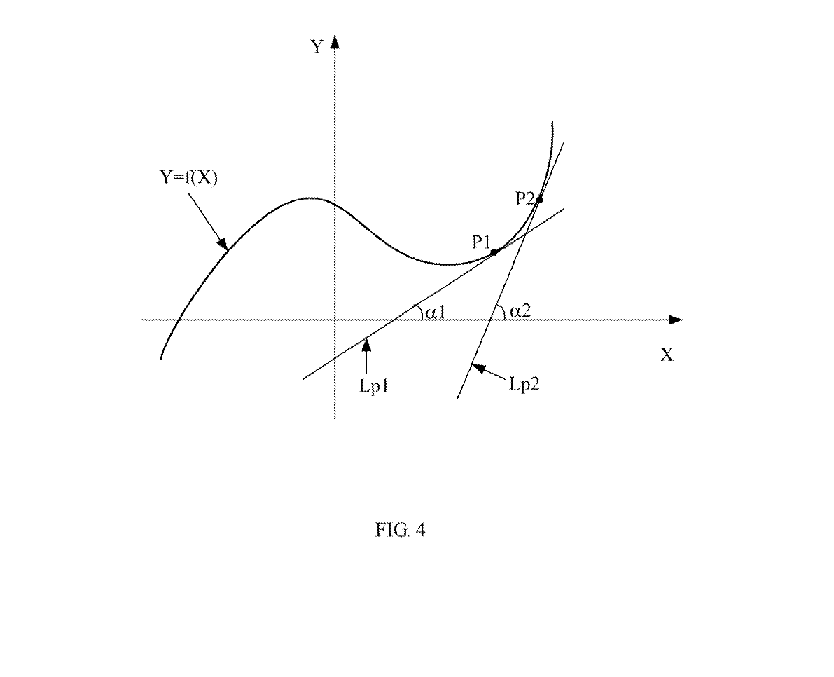

For example, when the object slides on the touch screen 20, the detection module 12 detects a set of consecutive contacts on the touch screen 20 and coordinates of the contacts, such as P1(X1, Y1), P2(X2, Y2), P3(X3, Y3). An equation f(X) of the movement route of the object on the touch screen 20 may be determined as: f(X)=A×X̂2+B×X+C, the coefficients A, B, and C can be determined according to P1(X1, Y1), P2(X2, Y2), P3(X3, Y3). Then, the determination module 13 can determine a tangential equation of a contact (such as the present contact) according to the equation f(X) of the movement route of the object on the touch screen 20 and the coordinates of the contact, and determine a tangential angle of the contact according to the tangential equation of the contact. As shown in FIG. 4, the curve Y=f(X) represents the movement route of the object on the touch screen 20, P1 and P2 are two contacts on the movement route, LP1 is a tangent of the contact P1, and LP2 is a tangent of the contact P2, α1 is a tangential angle of the contact P1, and α2 is a tangential angle of the contact P2.

In step S109, the detection module 12 detects coordinates (Xₘ₊₁, Yₘ₊₁) of a next contact Pₘ₊₁ (as shown in FIG. 3B) from the object on the touch screen 20. The determination module 13 determines a tangential equation, and a tangential angle a[m+1] of the next contact Pₘ₊₁ according to the equation F(X) of the movement route and the coordinates (Xₘ₊₁,Yₘ₊₁) of the next contact Pₘ₊₁. In this embodiment, the next contact Pₘ₊₁ may be a contact neighboring the present contact Pₙ, or there are a preset number of contacts (such as ten contact) between the present contact Pₙ and the next contact Pₘ₊₁.

In step S111, the determination module 13 determines a distance difference Δd and an angle difference Δα between the next contact Pₘ₊₁ and the present contact Pₙ.

In step S113, the determination module 14 determines if an absolute value of the angle difference Δα is less than a preset angle (such as five degrees). If the absolute value of the angle difference Δα is less than the preset angle (such as five degrees) (as shown in FIG. 3B), the determination module 13 determines that the file needs to be zoomed, and step S115 is implemented. Otherwise, if the absolute value of the angle difference Δα is equal to or more than the preset angle (as shown in FIG. 3C), the determination module 13 determines that the file needs to be rotated, and step S125 is implemented.

In step S115, the determination module 13 determines a zooming ratio f based on the distance difference Δd. For example, the zooming ratio f may be according to a formula: f=a1×x+b1, where x=Δd, a1 and b1 are predetermined constants.

In step S117, the determination module 13 determines if an orientation of the movement route is away from a center of the touch screen 20. For example, if |Xₘ₊₁|>|Xₙ| or |Yₘ₊₁|>|Yₙ|, the determination module 13 determines that the orientation of the movement route is away from the center of the touch screen 20, and step S119 is implemented. Otherwise, if |Xₘ₊₁|<|Xₙ| or |Yₘ₊₁|<|Yₙ|, the determination module 13 determines that orientation of the movement route is close to the center of the touch screen 20, and step S121 is implemented.

In step S119, the execution module 14 zooms out the file displayed on the touch screen by the zooming ratio. Then, the procedure goes to step S123.

In step S121, the execution module 14 zooms in the file displayed on the touch screen by the zooming ratio. Then, the procedure goes to step S123.

In step S123, the detection module 12 detects whether the object leaves the touch screen 20 or not. For example, if no further contact is detected, the detection module 12 determines that the object leaves the touch screen 20, and the procedure ends. Otherwise, if further contact is detected, the procedure will return to step S107 described above.

In step S113, if the determination module 13 determines that the file needs to be rotated, step S125 is implemented. In step S125, the determination module 13 determines a rotation angle R based on the angle difference Δα. For example, the rotation angle R may be determined according to a formula: R=a2×x+b1, where x=Δα, a2 and b2 are predetermined constants.

In step S127, the determination module 13 determines whether the rotation angle R is positive or negative. If the rotation angle R is positive, step S131 is implemented. Otherwise, if the rotation angle R is negative, step S129 is implemented.

In step S129, the execution module 14 rotates the file clockwise by the rotation angle. Then, the procedure goes to step S123 described above.

In step S131, the execution module 14 rotates the file counter-clockwise by the rotation angle. Then, the procedure goes to step S123 described above.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of an electronic device for controlling rotation or zooming operations of files displayed on a touch screen of the electronic device, the method comprising:
setting a condition for triggering the zooming operations or rotation operations of a file displayed on the touch screen;
determining an equation F(X) of a movement route of an object on the touch screen according to data in relation to three contacts from the object on the touch screen when the condition has been met;
detecting a present contact Pₙ(Xₙ, Yₙ) from the object on the touch screen, and determining a tangential angle a[n] of the present contact Pₙ(Xₙ, Yₙ) according to the equation F(X) of the movement route and the coordinates (Xₙ, Yₙ) of the present contact Pₙ;
detecting a next contact Pₘ₊₁(Xₘ₊₁, Yₘ₊₁) from the object on the touch screen, and determining a tangential angle a[m+1] of the next contact Pₘ₊₁ according to the equation F(X) of the movement route and the coordinates (Xₘ₊₁,Yₘ₊₁) of the next contact Pₘ₊₁;
determining a distance difference Δd and an angle difference Δα between the next contact Pₘ₊₁ and the present contact Pₙ;
determining the file needs to be rotated when an absolute value of the angle difference Δα is equal to or more than a preset angle, or determining the file needs to be zoomed when the absolute value of the angle difference Δα is less than the preset angle;
determining a rotation angle based on the angle difference Δα, and controlling a rotation operation of the file according to the rotation angle and the angle difference Δα when the file needs to be rotated; and
determining a zoom ratio based on the distance difference Δd, and controlling a zooming operation of the file according to the zoom ratio and an orientation of the movement route when the file needs to be zoomed.

2. The method of claim 1, wherein the condition is selected from the group consisting of two contacts are detected within a preset region of the touch screen within a preset time period, a preset button of a keyboard of the electronic device is pressed, and a preset icon displayed on the touch screen is pressed.

3. The method of claim 1, wherein the step of controlling the rotation operation of the file according to the rotation angle and the angle difference Δα comprises:
rotating the file clockwise by the rotation angle when the angle difference Δα is positive; and
rotating the file counter-clockwise by the rotation angle when the angle difference Δα is negative.

4. The method of claim 1, wherein the step of controlling a zooming operation of the file according to the zoom ratio and the orientation of the movement route comprises:
zooming out the file by the zooming ratio when the orientation of the movement route is away from a center of the touch screen; and
zooming in the file by the zooming ratio when the orientation of the movement route is close to the center of the touch screen.

5. The method of claim 1, wherein the next contact Pₘ₊₁ is a contact neighboring the present contact Pₙ, or there are a preset number of contacts between the present contact Pₙ and the next contact Pₘ₊₁.

6. A non-transitory computer-readable medium storing a set of instructions, the set of instructions capable of being executed by a processor of an electronic device to perform a method for controlling rotation or zooming operations of files displayed on a touch screen of the electronic device, the method comprising:
setting a condition for triggering the zooming operations or rotation operations of a file displayed on the touch screen;
determining an equation F(X) of a movement route of an object on the touch screen according to data in relation to three contacts from the object on the touch screen when the condition has been met;
detecting a present contact Pₙ(Xₙ, Yₙ) from the object on the touch screen, and determining a tangential angle a[n] of the present contact Pₙ(Xₙ, Yₙ) according to the equation F(X) of the movement route and the coordinates (Xₙ, Yₙ) of the present contact Pₙ;
detecting a next contact Pₘ₊₁(Xₘ₊₁, Yₘ₊₁) from the object on the touch screen, and determining a tangential angle a[m+1] of the next contact Pₘ₊₁ according to the equation F(X) of the movement route and the coordinates (Xₘ₊₁,Yₘ₊₁) of the next contact Pₘ₊₁;
determining a distance difference Δd and an angle difference Δα between the next contact Pₘ₊₁ and the present contact Pₙ;
determining the file needs to be rotated when an absolute value of the angle difference Δα is equal to or more than a preset angle, or determining the file needs to be zoomed when the absolute value of the angle difference Δα is less than the preset angle;
determining a rotation angle based on the angle difference Δα, and controlling a rotation operation of the file according to the rotation angle and the angle difference Δα when the file needs to be rotated; and
determining a zoom ratio based on the distance difference Δd, and controlling a zooming operation of the file according to the zoom ratio and an orientation of the movement route when the file needs to be zoomed.

7. The medium of claim 6, wherein the condition is selected from the group consisting of two contacts are detected within a preset region of the touch screen within a preset time period, a preset button of a keyboard of the electronic device is pressed, and a preset icon displayed on the touch screen is pressed.

8. The medium of claim 6, wherein the step of controlling the rotation operation of the file according to the rotation angle and the angle difference Δα comprises:
rotating the file clockwise by the rotation angle when the angle difference Δα is positive; and
rotating the file counter-clockwise by the rotation angle when the angle difference Δα is negative.

9. The medium of claim 6, wherein the step of controlling a zooming operation of the file according to the zoom ratio and the orientation of the movement route comprises:
zooming out the file by the zooming ratio when the orientation of the movement route is away from a center of the touch screen; and
zooming in the file by the zooming ratio when the orientation of the movement route is close to the center of the touch screen.

10. The medium of claim 6, wherein the next contact Pₘ₊₁ is a contact neighboring the present contact Pₙ, or there are a preset number of contacts between the present contact Pₙ and the next contact Pₘ₊₁.

11. An electronic device comprising:
a processor;
a storage device; and
one or more programs stored in the storage device and executed by the processor for performing operations of:
setting a condition for triggering zooming operations or rotation operations of a file displayed on the touch screen;
determining an equation F(X) of a movement route of an object on the touch screen according to data in relation to three contacts from the object on the touch screen when the condition has been met;
detecting a present contact Pₙ(Xₙ, Yₙ) from the object on the touch screen, and determining a tangential angle a[n] of the present contact Pₙ(Xₙ, Yₙ) according to the equation F(X) of the movement route and the coordinates (Xₙ, Yₙ) of the present contact Pₙ;
detecting a next contact Pₘ₊₁(Xₘ₊₁, Yₘ₊₁) from the object on the touch screen, and determining a tangential angle a[m+1] of the next contact Pₘ₊₁ according to the equation F(X) of the movement route and the coordinates (Xₘ₊₁,Yₘ₊₁) of the next contact Pₘ₊₁;
determining a distance difference Δd and an angle difference Δα between the next contact Pₘ₊₁ and the present contact Pₙ;
determining the file needs to be rotated when an absolute value of the angle difference Δα is equal to or more than a preset angle, or determining the file needs to be zoomed when the absolute value of the angle difference Δα is less than the preset angle;
determining a rotation angle based on the angle difference Δα, and controlling a rotation operation of the file according to the rotation angle and the angle difference Δα when the file needs to be rotated; and
determining a zoom ratio based on the distance difference Δd, and controlling a zooming operation of the file according to the zoom ratio and an orientation of the movement route when the file needs to be zoomed.

12. The device of claim 11, wherein the condition is selected from the group consisting of two contacts are detected within a preset region of the touch screen within a preset time period, a preset button of a keyboard of the electronic device is pressed, and a preset icon displayed on the touch screen is pressed.

13. The device of claim 11, wherein the operation of controlling the rotation operation of the file according to the rotation angle and the angle difference Δα comprises:
rotating the file clockwise by the rotation angle when the angle difference Δα is positive; and
rotating the file counter-clockwise by the rotation angle when the angle difference Δα is negative.

14. The device of claim 11, wherein the operation of controlling a zooming operation of the file according to the zoom ratio and the orientation of the movement route comprises:
zooming out the file by the zooming ratio when the orientation of the movement route is away from a center of the touch screen; and
zooming in the file by the zooming ratio when the orientation of the movement route is close to the center of the touch screen.

15. The device of claim 11, wherein the next contact Pₘ₊₁ is a contact neighboring the present contact Pₙ, or there are a preset number of contacts between the present contact Pₙ and the next contact Pₘ₊₁.
